(19) United States
(12) Patent Application Publication
(10) Pub. No.: US 2021/0334593 A1
(43) Pub. Date: Oct. 28, 2021

(54) RECOMMENDING SCRIPTS FOR CONSTRUCTING MACHINE LEARNING MODELS

(71) Applicant: AT&T Intellectual Property I, L.P., Atlanta, GA (US)

(72) Inventors: Chris Vo, Sachse, TX (US); Jeremy T. Fix, Acworth, GA (US); Robert Woods, JR., Plano, TX (US)

(21) Appl. No.: 16/861,177

(22) Filed: Apr. 28, 2020

(51) Int. Cl. G06K 9/62; G06N 20/00; G06N 7/00

(52) U.S. Cl. CPC G06K 9/6256; G06K 9/6232; G06N 7/005; G06N 20/00; G06K 9/6277

(57) ABSTRACT

An example method includes building a set of test data for a machine learning model, in response to receiving a target data set from a user, wherein the target data set is a data set on which the machine learning model is to be trained to operate, identifying a subset of predefined features engineering action scripts from among a plurality of predefined features engineering action scripts, wherein the subset is determined to be applicable to the set of test data, and automatically generating a recommended features engineering action script for operating on the target data set, wherein the automatically generating includes customizing a parameter of a predefined features engineering action script of the subset to extract data values from locations in the target data set, and wherein the recommended features engineering action script is recommended to the user for inclusion in a features engineering component of the machine learning model.

The present disclosure relates generally to artificial intelligence, and relates more particularly to devices, non-transitory computer-readable media, and methods for automatically recommending predefined scripts for constructing machine learning models.

### BACKGROUND

Machine learning is a subcategory of artificial intelligence that uses statistical models, executed on computers, to perform specific tasks. Rather than provide the computers with explicit instructions, the statistical models are used by the computers to learn patterns and predict the correct tasks to perform. The statistical models may be trained using a set of sample or training data (which may be labeled or unlabeled), which helps the computers to learn the patterns. At run time, new data is processed based on the learned patterns to predict the correct tasks from the new data. Machine learning therefore may be used to automate tasks in a wide variety of applications, including virtual personal assistants, email filtering, computer vision, customer support, fraud detection, and other applications.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for constructing machine learning models may operate;

FIG. 2 illustrates a high level block diagram illustrating a machine learning model that may be constructed using the application server of FIG. 1;

FIG. 3 illustrates a flowchart of an example method for constructing machine learning models, in accordance with the present disclosure;

FIG. 4A illustrates one example of a first user interface, according to the present disclosure;

FIG. 4B illustrates one example of a second user interface which has been configured based on inputs to the first user interface of FIG. 4A;

FIG. 5 illustrates a flow diagram illustrating an example method for training a recommendation system to identify predefined features engineering action scripts that may act on a set of test data;

FIG. 6 illustrates a flow diagram illustrating an example method for automatically recommending predefined scripts for constructing machine learning models;

FIG. 7 illustrates an example table showing one example of a transformed target data set that may be generated as a result of one or more predefined features engineering action scripts operating on the target data set of Table 2; and

FIG. 8 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for automatically recommending predefined scripts for constructing machine learning models. In one example, a method performed by a processing system including at least one processor includes building a set of test data for a machine learning model, wherein the building is performed in response to receiving a target data set from a user, wherein the target data set is a data set on which the machine learning model is to be trained to operate, identifying a subset of predefined features engineering action scripts from among a plurality of predefined features engineering action scripts, wherein the subset of predefined features engineering action scripts is determined to be applicable to the set of test data, and automatically generating a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

In another example, a non-transitory computer-readable medium may store instructions which, when executed by a processing system in a communications network, cause the processing system to perform operations. The operations may include building a set of test data for a machine learning model, wherein the building is performed in response to receiving a target data set from a user, wherein the target data set is a data set on which the machine learning model is to be trained to operate, identifying a subset of predefined features engineering action scripts from among a plurality of predefined features engineering action scripts, wherein the subset of predefined features engineering action scripts is determined to be applicable to the set of test data, and automatically generating a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

In another example, a device may include a processing system including at least one processor and a non-transitory computer-readable medium storing instructions which, when executed by the processing system when deployed in a communications network, cause the processing system to perform operations. The operations may include building a set of test data for a machine learning model, wherein the building is performed in response to receiving a target data set from a user, wherein the target data set is a data set on which the machine learning model is to be trained to operate, identifying a subset of predefined features engineering action scripts from among a plurality of predefined features engineering action scripts, wherein the subset of predefined features engineering action scripts is determined to be applicable to the set of test data, and automatically generating a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

As discussed above, machine learning uses statistical models, executed on computers, to perform specific tasks. Rather than provide the computers with explicit instructions, the statistical models are used by the computers to learn patterns and to predict the correct tasks to perform. The statistical models may be trained using a set of sample or training data (which may be labeled or unlabeled), which helps the computers to learn the patterns. At run time, new data (test data) is processed based on the learned patterns to predict the correct tasks from the new data. Machine learning therefore may be used to automate tasks in a wide variety of applications, including virtual personal assistants, email filtering, computer vision, customer support, fraud detection, and other applications.

The construction of machine learning models is a complicated process that is typically performed by data scientists who have advanced software and programming knowledge. However, these data scientists may lack the specific domain expertise needed to ensure that the machine learning models perform effectively for their intended purposes. For instance, a machine learning model that is constructed to function as a virtual personal assistant should behave differently than a machine learning model that is constructed to function as a customer support tool. An effective machine learning model must be able to learn how the specific types of data the model receives as input (e.g., an incoming text message from a specific phone number, versus keywords in a query posed to a customer support chat bot) map to specific tasks or actions (e.g., silencing a text message alert, versus identifying a department to which to direct a customer query).

Moreover, even within the same domain, separate machine learning models are often constructed for each machine learning problem. In some cases, multiple versions of machine learning models may even be created for the same machine learning problem, where each version may include different experimental feature engineering code logic. The various combinations of copies of model code may therefore become very expensive to store and maintain.

Examples of the present disclosure expose the internal logic of machine learning modeling in order to make the construction of machine learning models a more configuration-driven, and therefore more user-friendly, task. In other words, the exposure of the internal logic makes it possible for an individual who may possess expertise in a particular domain, but who may lack knowledge of data science and programming, to construct an effective machine learning model for a domain problem. In one particular example, the portions of the internal logic that are exposed comprise the feature engineering portions of the machine learning model, e.g., the logic blocks that define the features that will be extracted from raw input data and processed by a machine learning algorithm in order to generate a prediction.

In one example, the present disclosure defines a set of rules (e.g., standards) as atomic building blocks for constructing a machine learning model. From these building blocks, a user may “programmatically” construct a machine learning model by manipulating the configuration file of the model with a human language-like syntax (e.g., a syntax that is closer to human language—such as English—than to computer syntax) in order to tailor the machine learning model to a specific problem or use case.

In further examples, the present disclosure provides a system and user interface that allows the scripts (logic blocks) for the atomic building blocks to be crowdsourced. In other words, examples of the present disclosure allow users to create, upload, and save generic scripts, including scripts for features engineering, to a library of scripts. Other users may later access these generic scripts and customize the generic scripts by setting the values for various parameters of the scripts. Customization of a generic script may result in the creation of an action block for performing a specific features engineering task. The action block may then be used to populate a configuration file for a machine learning model, where the action block defines the features that the machine learning model will extract from test data and apply a machine learning algorithm to.

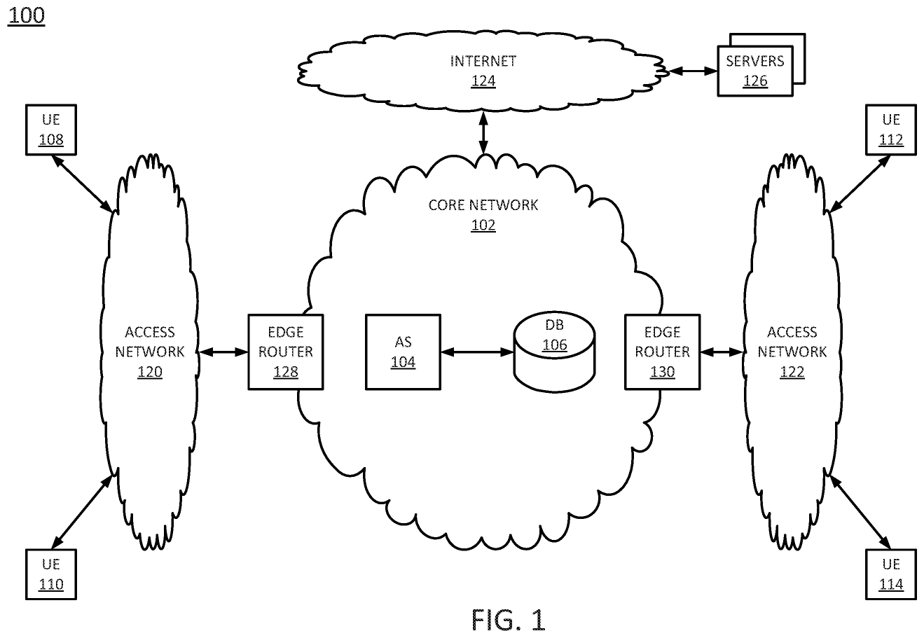

In still further examples, the present disclosure may assist a user who is constructing a machine learning model by recommending predefined scripts based on the test data to be processed by the machine learning model. For instance, the user may provide a set of test data to a recommendation engine. The recommendation engine may have access to an inventory of available scripts and the histories of usage of those scripts (e.g., which scripts have been used is which machine learning models). The recommendation engine may train the available scripts and then feed the test data to the trained available scripts in order to determine which of the trained available scripts may be applicable to the test data. These and other aspects of the present disclosure are discussed in greater detail below in connection with the examples of FIGS. 1-8.

To further aid in understanding the present disclosure, FIG. 1 illustrates an example system 100 in which examples of the present disclosure for constructing machine learning models may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider. The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like.

In one example, one or more servers 126 may be accessible to user endpoint devices 108, 110, 112, and 114 via Internet 124 in general. The server(s) 126 may operate in a manner similar to the AS 104, which is described in further detail below.

In accordance with the present disclosure, the AS 104 may be configured to provide one or more operations or functions in connection with examples of the present disclosure for recommending scripts for automatically recommending predefined scripts for constructing machine learning models, as described herein. For instance, the AS 104 may be configured to operate as a Web portal or interface via which a user endpoint device, such as any of the UEs 108, 110, 112, and/or 114, may access various predefined logic blocks and machine learning algorithms. The AS 104 may further allow the user endpoint device to manipulate the predefined logic blocks and machine learning algorithms in order to construct a machine learning model that is tailored for a specific use case. For instance, as discussed in further detail below, manipulation of the predefined logic blocks may involve setting parameters of the logic blocks and/or arranging the logic blocks in a pipeline-style execution sequence in order to accomplish desired feature engineering for the machine learning model. Manipulation of the machine learning algorithms may involve selecting one or more specific machine learning algorithms to process features extracted from raw test data (e.g., in accordance with the desired feature engineering) and/or specifying a manner in which to combine the outputs of multiple machine learning models to generate a single prediction.

In some examples, the AS 104 may further function as a recommendation engine that recommends predefined logic blocks which might be implemented as part of a machine learning model to process a set of test data, based on features of the test data. The recommendation feature may provide additional assistance to users who may lack software engineering and/or programming expertise, as it knows what predefined logic blocks are available and how the predefined logic blocks have been used in the past, (e.g., what sorts of features the predefined logic blocks have been used to extract).

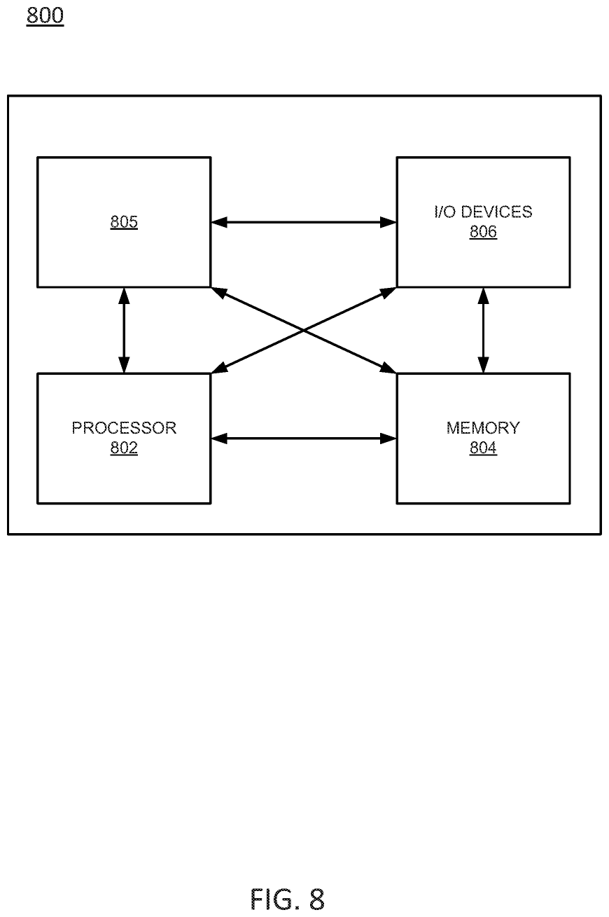

In accordance with the present disclosure, the AS 104 may comprise one or more physical devices, e.g., one or more computing systems or servers, such as computing system 800 depicted in FIG. 8, and may be configured as described above. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 8 and discussed below) or multiple computing devices collectively configured to perform various steps, functions, and/or operations in accordance with the present disclosure.

The AS 104 may have access to at least one database (DB) 106, where the DB 106 may store the predefined logic blocks that may be manipulated in order to perform feature engineering for a machine learning model. In one example, at least some of these predefined logic blocks are atomic and generic, which allows the predefined logic blocks to be reused for various different use cases (e.g., for various machine learning models that are programmed to carrying out various different tasks). Metadata associated with the predefined logic blocks may indicate machine learning models in which the predefined logic blocks have previously been used. In one example, at least some of the predefined logic blocks may be crowdsourced, e.g., contributed by individual users of the system 100 who may have software engineering and/or programming expertise.

The DB 106 may also store a plurality of different machine learning algorithms that may be selected for inclusion in a machine learning model. Some of these machine learning algorithms are discussed in further detail below; however, the DB may also store additional machine learning algorithms that are not explicitly specified. In addition, the DB 106 may store constructed machine learning models. This may help the AS 104, for instance, to identify the most frequently reused predefined logic blocks, to recommend predefined logic blocks for particular uses (based on previous uses of the predefined logic blocks), and to allow for sharing of the constructed machine learning models among users.

In one example, DB 106 may comprise a physical storage device integrated with the AS 104 (e.g., a database server or a file server), or attached or coupled to the AS 104, to store predefined logic blocks, machine learning algorithms, and/or machine learning models, in accordance with the present disclosure. In one example, the AS 104 may load instructions into a memory, or one or more distributed memory units, and execute the instructions for automatically recommending predefined scripts for constructing machine learning models, as described herein. An example method for automatically recommending predefined scripts for constructing machine learning models is described in greater detail below in connection with FIG. 6.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

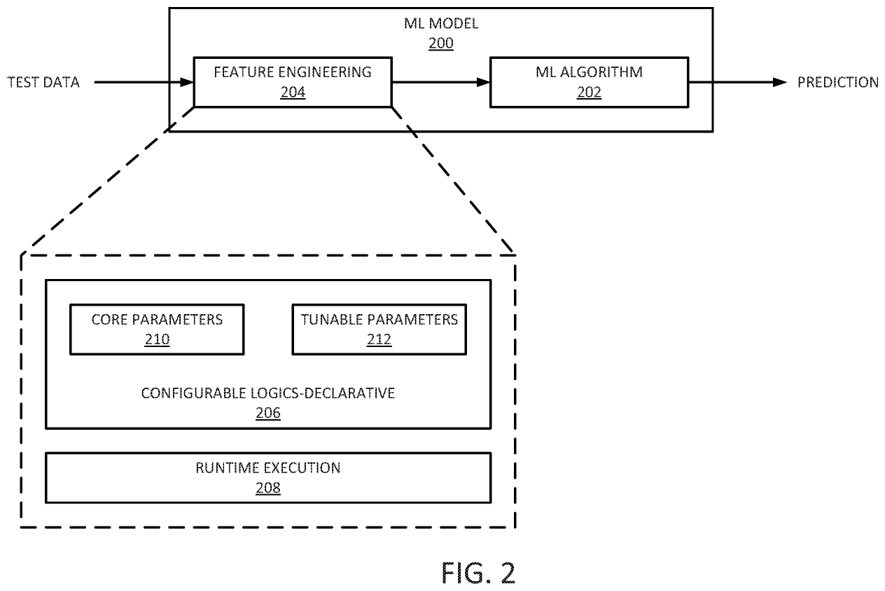

FIG. 2 is a high level block diagram illustrating a machine learning model 200 that may be constructed using the AS 104 of FIG. 1. In one example, the machine learning model 200 generally comprises a machine learning algorithm 202 and a feature engineering component 204, as discussed above.

In one example, the machine learning algorithm 202 is an algorithm that takes test data as input, and, based on processing of the test data, generates a prediction as an output. The prediction may comprise an appropriate action to be taken in response to the test data. As the machine learning algorithm 202 is exposed to more data over time, the machine learning algorithm 202 may adjust the manner in which incoming test data is processed (e.g., by adjusting one or more parameters of the machine learning algorithm 202) in order to improve the quality of the predictions. For instance, the machine learning algorithm 202 may receive feedback regarding the quality of the predictions, and may adjust one or more parameters in response to the feedback in order to ensure that high-quality predictions are generated more consistently. In one example, the machine learning algorithm 202 may initially be trained on a set of training data (which may be labeled or unlabeled). However, even after training, the machine learning algorithm 202 may continue to adjust the parameters as more test data is processed. In one example, the machine learning algorithm 202 may be any machine learning model, such as a gradient boost machine (GBM) algorithm, an extreme gradient boosting (XGBoost) algorithm, a LightGBM algorithm, or a random forest algorithm, for instance.

In one example, the features engineering component 204 utilizes at least one data mining technique in order to extract useful features from the test data. The features engineering component 204 may rely on domain knowledge (e.g., knowledge of the domain for which the machine learning model 200 is being constructed) in order to define the features that should be extracted from the test data. In one example, the feature engineering component 204 comprises a set of configurable logics 206 and a runtime execution component 208.

The set of configurable logics 206 may generally comprise components of the machine learning model 200 that can be configured by a user. For instance, examples of the present disclosure may present a system and user interface that allow a user to configure and customize certain parameters of the machine learning model 200 for a particular use. As discussed in further detail below, some of these parameters may be encoded in programming blocks. The programming blocks may be reusable in the sense that the programming block generally define certain aspects of the corresponding parameters, while allowing the user to customize these aspects through the definition of specific values. In one example, the set of configurable logics 206 may include a set of core parameters 210 and a set of tunable parameters 212.

In one example, the set of core parameters 210 may include programmable operation logic blocks for basic operations (e.g., load data, save data, fetch remote data, etc.), where the operation logic blocks can be combined, and the values for the operation logic blocks can be defined, to construct more complex operations. For instance, a sequence of the basic operations, when executed in order, may result in a more complex operation being performed.

In one example, the set of tunable parameters 212 may include blocks of predefined code logic that may be used to extract common feature types. For instance, a common feature type may comprise a number of days elapsed between two events, a total number of words in a string of text, or some other feature type. The specifics of the feature type may vary based on application. For instance, for a machine learning model that is designed to detect fraudulent claims for mobile phone replacements, the number of days elapsed between the activation date of a mobile phone and a date a claim for replacement of the mobile phone was submitted may be a feature that one would want to extract. However, for a machine learning model that is designed to remind a user to take a prescribed medication (e.g., a virtual personal assistant), the number of days elapsed between the last time the user took the prescribed medication and the current day may be a feature that one would want to extract. Thus, a predefined code logic block to extract the number of days elapsed between events may be customized by specifying the events for which the dates are to be extracted. The events may be specified by indicating a column of a data set in which the dates of the events are recorded.

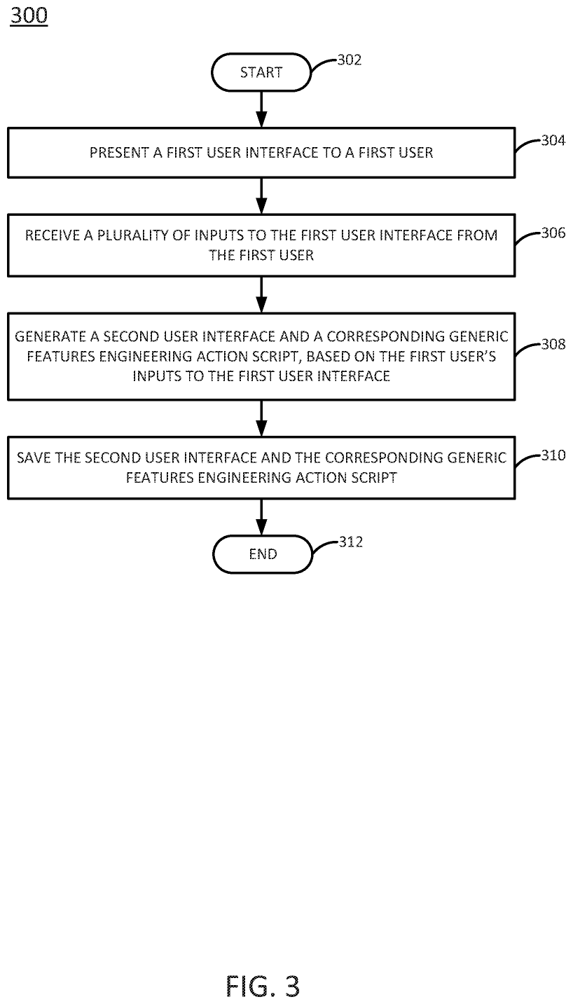

FIG. 3 illustrates a flowchart of an example method 300 for constructing machine learning models, in accordance with the present disclosure. In one example, steps, functions and/or operations of the method 300 may be performed by a device as illustrated in FIG. 1, e.g., AS 104 or any one or more components thereof. In one example, the steps, functions, or operations of method 300 may be performed by a computing device or system 800, and/or a processing system 802 as described in connection with FIG. 8 below. For instance, the computing device 800 may represent at least a portion of the AS 104 in accordance with the present disclosure. For illustrative purposes, the method 300 is described in greater detail below in connection with an example performed by a processing system, such as processing system 802.

The method 300 begins in step 302 and proceeds to step 304. At step 304, the processing system may present a first user interface to a first user. In one example, the first user interface may be presented via a user endpoint device operated by the first user. The first user interface may comprise an interface that allows the first user to configure a generic features engineering action script, where the generic features engineering action script is configured to assist a second user (different from the first user) in constructing a customized script for the features engineering component of a machine learning model.

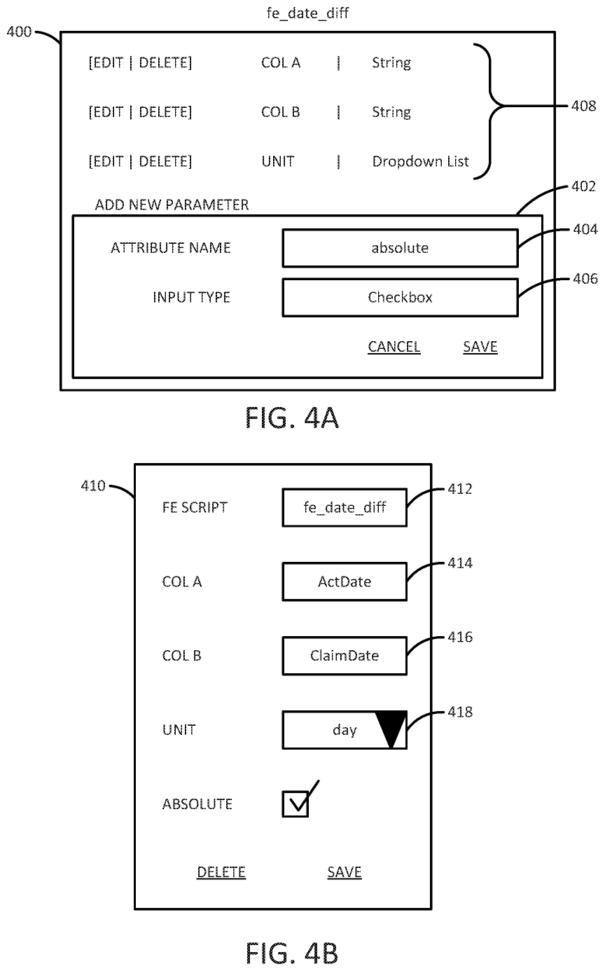

FIG. 4A, for instance, illustrates one example of a first user interface 400, according to the present disclosure. The first user interface 400 may be used to configure a user interface for constructing a first features engineering action script (e.g., a script that acts one or more data items and optionally produces an output as a result of acting on the data item(s)). In the example of FIG. 4A, the first user interface 400 is used to configure an example action script named fe_date_diff. The example action script may be used to calculate an amount of time elapsed (a difference) between two dates.

As illustrated, the first user interface 400 may include a parameter definition section 402. The parameter definition section 402 may allow the parameters of the first features engineering action script (e.g., the number and/or format of the first features engineering action script's input and outputs) to be defined. In one example, the parameter definition section 402 may include a first field 404 that allows an attribute name to be defined. The attribute name may correspond to a data item on which the first features engineering action script is to act or a format of the first feature engineering action script's output. The first user interface 400 may also include a second field 406 that allows an input type (e.g., text string, dropdown list, etc.) of the data item defined in the first field 404 to be defined.

Referring back to FIG. 3, in step 306, the processing system may receive a plurality of inputs to the first user interface from the first user. The plurality of inputs may be received via fields of the first user interface (as discussed in connection with FIG. 4A) and may allow the processing system to define a list of parameters for the first features engineering action script.

For instance, referring again to FIG. 4A, the processing system may receive inputs from the first user that allow the processing system to define the example list 408 of parameters for the first features engineering action script. The example list 408 includes the attribute names “col A” and “col B,” which may indicate columns of a dataset from which data items are to be extracted. The input types for “col A” and “col B” may both be text strings. The example list 408 may also include the attribute name “unit,” which may indicate a unit of measure for the difference between the data items extracted from column A and column B. The input type for “unit” may be a dropdown list.

Referring back to FIG. 3, in step 308, the processing system may generate a second user interface and a corresponding generic features engineering action script, based on the first user's inputs to the first user interface. The second user interface may include a plurality of fields via which the second user may customize the generic first features engineering action script for implementation in a machine learning model.

FIG. 4B, for instance, illustrates one example of a second user interface 410 which has been configured based on inputs to the first user interface 400 of FIG. 4A. The example second user interface 410 may include a first field 412 that specifies the name of the features engineering action script that can be customized via the second user interface 410 (e.g., fe_date_diff).

The example second user interface 410 may further include second and third fields 414 and 416, respectively, to specify the locations (columns) in an input dataset that correspond to the “Col A” and “Col B” parameters discussed above (i.e., locations from which to retrieve data to be processed by the features engineering action script). As discussed above, the fe_date_diff script may compute a time elapsed between two dates, e.g., by subtracting a value in a first column of the input dataset (column A) from a value in a second column of the input dataset (column B).

A fourth field 418 of the example second user interface 410 may provide a drop down menu that allows the user to select the unit of measure for the features engineering action script's output, e.g., a computed difference (which in the example of FIGS. 4A and 4B may be stated in terms of days, weeks, months, etc.).

In use, when the example second user interface 410 is configured as shown in FIG. 4B, a features engineering action script may be generated for implementation in the configuration file of a machine learning model.

Referring back to FIG. 3, in step 310, the processing system may save the second user interface and the corresponding generic features engineering action script, e.g., in a library of generic features engineering action scripts. As discussed above, the library of generic features engineering action scripts may be accessible to users who may wish to utilize the generic features engineering action scripts to construct the features engineering component of a machine learning model.

The method 300 may end in step 312.

It should be noted that although the method 300 provides a first user interface via which the first user may configure a second user interface and corresponding features engineering action script, the first user may also write the features engineering action script without using the first user interface (particularly if the first user has some software programming expertise). However the generic features engineering action scripts are generated, the generic features engineering action scripts may be stored (along with corresponding user interfaces that allow the generic features engineering action scripts to be customized) for use (and reuse) by other users.

Thus, additional generic features engineering action scripts can be generated in a manner similar to that described in connection with FIG. 3. For instance, generic features engineering action scripts may be generated to compute a numerical different between two numbers, a difference in spread between two zip codes, a word count of a data item, or other outputs.

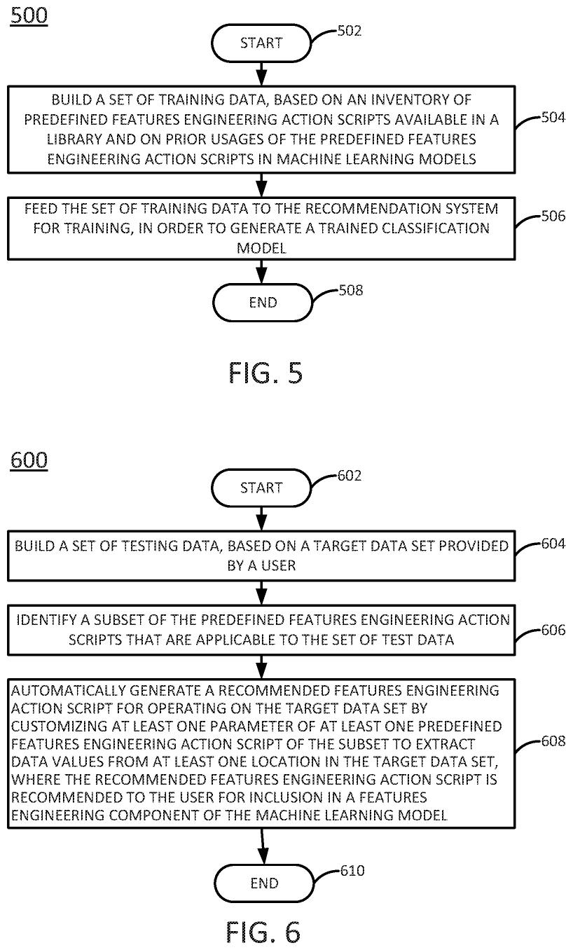

In some cases, examples of the present disclosure may go a step further and provide recommendations to a user regarding generic features engineering action scripts that the user may wish to use when constructing a machine learning model. FIG. 5, for instance, is a flow diagram illustrating an example method 500 for training a recommendation system to identify predefined features engineering action scripts that may act on a set of test data. In one example, steps, functions and/or operations of the method 500 may be performed by a device as illustrated in FIG. 1, e.g., AS 104 or any one or more components thereof. In one example, the steps, functions, or operations of method 500 may be performed by a computing device or system 800, and/or a processing system 802 as described in connection with FIG. 8 below. For instance, the computing device 500 may represent at least a portion of the AS 104 in accordance with the present disclosure. For illustrative purposes, the method 500 is described in greater detail below in connection with an example performed by a processing system, such as processing system 802.

The method 500 begins in step 502 and proceeds to step 504. At step 504, the processing system may build a set of training data, based on an inventory of predefined features engineering action scripts available in a library and on prior usages of the predefined features engineering actions scripts in machine learning models. For instance, in one example, the predefined features engineering action scripts may be indexed according to machine learning models in which the predefined features engineering action scripts have been used. Examining the machine learning models in which the predefined features engineering action scripts have been used may allow the processing system to identify potential uses cases for the features engineering action scripts. As discussed above, features engineering action scripts may be written in a generic manner, such that the features engineering action scripts can be reused in various different contexts via customization (e.g., defining different values for the attributes of the features engineering action scripts). For instance, a generic features engineering action script that computes a difference between two values may be used to compute a spread between zip codes, a difference between a maximum computing resource usage and an actual computing resource usage, a difference between a number of miles driven by a car as of a first date and a number of miles driven by the car as of a second, subsequent date, or any other numerical difference depending on the usage case of a machine learning model.

Building the set of training data may comprise identifying the types of data (e.g., dates, integers, floating-point numbers, text strings, etc.) on which the predefined features engineering action scripts have been used to operate. For instance, Table 1, below, illustrates an example set of training data that may be built based on an examination of the inventory of predefined features engineering action scripts:

TABLE 1
Example Training Data Set

| ID | Apply? | FE Script | ColA_DataType | ColB_DataType |
|---|---|---|---|---|
| 1 | Yes | fe_date_diff | Date | Date |
| 2 | No | fe_date_diff | Date | NULL |
| 3 | No | fe_date_diff | Integer | Integer |
| 4 | No | fe_date_diff | Integer | NULL |
| 5 | No | fe_date_diff | Floating | NULL |
| 6 | Yes | fe_word_count | String | NULL |
| 7 | No | fe_word_count | Integer | NULL |

It should be noted that, in practice, the set of training data may comprise a larger number of attributes (data types) and records than is shown in Table 1 (which is simplified for ease of explanation). For instance, additional attributes or data types that may be extracted from the records may include categorical indicators for tags that may be popular for a specific use case (e.g., in the example of Table 1, such tags may include “tag_is_fraud,” “tag_is_churn,” “tag is network,” “tag_is_finance,” and the like). Additional features engineering scripts may be available once additional contributions are submitted to the scripts inventory to solve additional use cases. In general, the accuracy of the recommendation system will improve as the recommendation system is exposed to more attributes and more records.

In step 506, the processing system may feed the set of training data to the recommendation system for training, in order to generate a trained classification model. The recommendation system in this case may function as a classification model that can classify a data type according to the types of predefined features engineering action scripts that the data type may be operated on by.

The method 500 may end in step 508. It should be noted, however, that steps 504 and 506 may be repeated any number of times in order to improve the accuracy of the classification model. For instance, steps 504 and 506 may be repeated periodically (e.g., daily, weekly, etc.), randomly, or in response to the occurrence of a predefined action (e.g., a threshold number of new features engineering scripts being added to the library).

FIG. 6 is a flow diagram illustrating an example method 600 for automatically recommending predefined scripts for constructing machine learning models. In one example, steps, functions and/or operations of the method 600 may be performed by a device as illustrated in FIG. 1, e.g., AS 104 or any one or more components thereof. In one example, the steps, functions, or operations of method 600 may be performed by a computing device or system 800, and/or a processing system 802 as described in connection with FIG. 8 below. For instance, the computing device 800 may represent at least a portion of the AS 104 in accordance with the present disclosure. For illustrative purposes, the method 600 is described in greater detail below in connection with an example performed by a processing system, such as processing system 602.

The method 600 begins in step 602 and proceeds to step 604. At step 604, the processing system may build a set of test data, based on a target data set provided by a user. For instance, the target data set may be a set of data for which the user wishes to build a machine learning model (i.e., a data set on which the machine learning model is to operate). The user may also specify a use case associated with the target data set, where the use case defines the information that the user wishes to extract from the target data set. As an example, the user may want to examine a target data set of records relating to customer claims for replacement mobile phones in order to detect which claims are potentially fraudulent (use case). Table 2, below, illustrates an example target data set relating to customer claims for replacement mobile phones (where the target data set has been simplified for ease of explanation, similar to Table 1 above):

TABLE 2
Example Target Data Set

| ID | ActDate | ClaimDate | Description | BillZip | ShipZip | Fraud? |
|---|---|---|---|---|---|---|
| 1 | Mar. 7, 2019 | Aug. 4, 2019 | White Phone X 64 MB | 75040 | 75022 | 0 |
| 2 | Jul. 9, 2019 | Aug. 5, 2019 | Black Phone Y 255 MB | 75092 | 50214 | 1 |
| 3 | Feb. 6, 2019 | Aug. 2, 2019 | Black Phone Z | 78302 | 78302 | 0 |
| 4 | Jun. 3, 2019 | Jul. 6, 2019 | Black Phone Z 255 MB | 52342 | 43657 | 1 |

In one example, building the set of test data based on the target data set involves formatting the test data set to specify the data types of the data contained in the target data set. For instance, the ActDate and Claim Date columns of the example target data set of Table 2 contain dates, while the Description column contains text strings, and the BillZip and ShipZip columns contain integers. Thus, an example set of test data that may be built from the example target data set of Table 2 may be represented as shown in Table 3A, below:

TABLE 3A
Example Set of Test Data

| ID | Apply? | FE Script | ColA_DataType | ColB_DataType |
|---|---|---|---|---|
| 991 | | fe_date_diff | Integer | NULL |
| 992 | | fe_date_diff | Integer | Integer |
| 993 | | fe_date_diff | Floating | NULL |
| 994 | | fe_date_diff | Floating | Floating |
| 995 | | fe_date_diff | Date | NULL |
| 996 | | fe_date_diff | Date | Date |
| 997 | | fe_word_count | Integer | NULL |
| 998 | | fe_word_count | String | NULL |

In one example, the set of test data is built against all possible values of the predefined features engineering action scripts in a library of predefined features engineering actions scripts.

In step 606, the processing system may identify a subset of the predefined features engineering action scripts that are applicable to the set of test data. In one example, the applicable subset of the predefined features engineering action scripts may be identified by feeding the set of test data built in step 604 to a recommendation system (which may have been trained in accordance with the method 500, described above).

For instance, in Table 3A each record (ID) in the target data set may be compared against each predefined features engineering action script (FE Script) in order to determine whether the data types contained in the record are the same as the data types on which the predefined features engineering action script operates. If the data types contained in the record are the same as the data types on which the predefined features engineering action script operates, then the predefined features engineering action script may be considered potentially applicable to the record. In this case, the Apply column of Table 3A may be updated, as indicated in Table 3B, below, to indicate whether or not the predefined features engineering action script is applicable to the record.

TABLE 3B
Example Set of Test Data (Updated)

| ID | Apply | FE Script | ColA_DataType | ColB_DataType |
|---|---|---|---|---|
| 991 | No | fe_date_diff | Integer | NULL |
| 992 | No | fe_date_diff | Integer | Integer |
| 993 | No | fe_date_diff | Floating | NULL |
| 994 | No | fe_date_diff | Floating | Floating |
| 995 | No | fe_date_diff | Date | NULL |
| 996 | Yes | fe_date_diff | Date | Date |
| 997 | No | fe_word_count | Integer | NULL |
| 998 | Yes | fe_word_count | String | NULL |

In step 608, the processing system may automatically generate a recommended features engineering action script for operating on the target data set, by customizing at least one parameter of at least one predefined features engineering action script of the subset to extract data values from at least one location in the target data set. The recommended features engineering action script may be recommended for inclusion in a features engineering component of the machine learning model that is to operate on the target data set.

For instance, in one example, the processing system may select a first predefined features engineering action script from the subset of the predefined features engineering action scripts, where the first predefined features engineering action script was determined to be applicable to the test data as discussed above. The processing system may then map the first predefined features engineering actions script back to the target data set in order to determine which locations (columns) of the data set can provide values for the parameters of the first predefined features engineering action script. For instance, referring back to the example fe_date_diff script, the “col A” parameter may map to the “ActDate” column of Table 2, while the “col B” parameter may map to the “ClaimDate” column of Table 2. Thus, the automatically generated recommended features engineering action script may read as:

{

| | |
|---|---|
| “action_name” | : “fe_date_diff”, |
| “parameters” | : { |

| | |
|---|---|
| “col_A” | : “ActDate”, |
| “col_B” | : “ClaimDate”, |
| “unit” | : “”day”, |
| “absolute” | : true |

}

}

The automatically generated recommended features engineering action script may be used to populate a configuration file for a machine learning model that may be trained to operate on the target data set and similar data sets.

The method 600 may end in step 610.

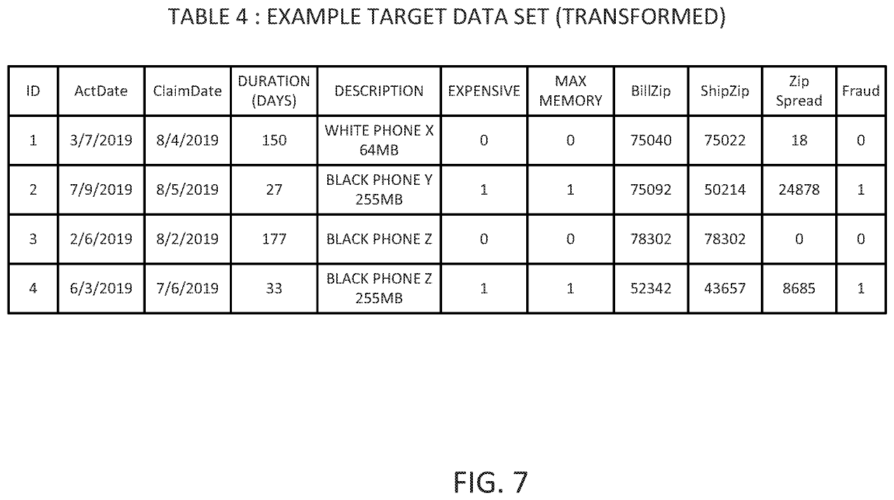

An automatically recommended features engineering action script that is generated according to FIG. 6 may be used to apply a transformation (feature engineering) to the target data set. The transformation may result in data being added to the target data set (e.g., columns being added) as a result of one or more predefined features engineering action scripts operating on the target data set. FIG. 7, for instance, illustrates an example table (Table 4) showing one example of a transformed target data set that may be generated as a result of one or more predefined features engineering action scripts operating on the target data set of Table 2. Based on the example of Table 4, it may be seen that a claim for a replacement mobile phone is more likely to be fraudulent when the mobile phone being replaced is expensive (e.g., costs more than a threshold price), when the mobile phone being replaced has a maximum memory size (e.g., a memory size that is at least a threshold size), when the claim for the replacement mobile phone is submitted shortly after the mobile phone is activated (e.g., the number of days between activation and claim submission is less than a threshold), and/or the spread between the billing zip code and the zip code to which the replacement mobile phone is to be shipped is large (e.g., greater than a threshold spread).

It should be noted that the methods 300, 500, and 600 may be expanded to include additional steps or may be modified to include additional operations with respect to the steps outlined above. In addition, although not specifically specified, one or more steps, functions, or operations of the methods 300, 500, and 600 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 3, 5, and 6 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 8 depicts a high-level block diagram of a computing device or processing system specifically programmed to perform the functions described herein. As depicted in FIG. 8, the processing system 800 comprises one or more hardware processor elements 802 (e.g., a central processing unit (CPU), a microprocessor, or a multi-core processor), a memory 804 (e.g., random access memory (RAM) and/or read only memory (ROM)), a module 805 for automatically recommending predefined scripts for constructing machine learning models, and various input/output devices 806 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the methods 300, 500, and 600 as discussed above are implemented in a distributed or parallel manner for a particular illustrative example, i.e., the steps of the above methods 300, 500, and 600 or the entire methods 300, 500, and 600 are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 802 can also be configured or programmed to cause other devices to perform one or more operations as discussed above. In other words, the hardware processor 802 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods 300, 500, and 600. In one example, instructions and data for the present module or process 805 for automatically recommending predefined scripts for constructing machine learning models (e.g., a software program comprising computer-executable instructions) can be loaded into memory 804 and executed by hardware processor element 802 to implement the steps, functions, or operations as discussed above in connection with the illustrative methods 300, 500, and 600. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 805 for automatically recommending predefined scripts for constructing machine learning models (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
building, by a processing system including at least one processor, a set of test data for a machine learning model, wherein the building is performed in response to receiving a target data set from a user, wherein the target data set is a data set on which the machine learning model is to be trained to operate;
identifying, by the processing system, a subset of predefined features engineering action scripts from among a plurality of predefined features engineering action scripts, wherein the subset of predefined features engineering action scripts is determined to be applicable to the set of test data; and
automatically generating, by the processing system, a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

2. The method of claim 1, further comprising:
receiving, by the processing system, a use case for the machine learning model from the user, wherein the use case defines information that the user wishes to extract from the target data set.

3. The method of claim 1, wherein the target data set comprises data presented in a plurality of columns.

4. The method of claim 1, wherein the building comprises:
formatting, by the processing system, the set of test data to specify data types of data contained in the set of target data.

5. The method of claim 1, wherein a predefined features engineering action script of the subset of predefined features engineering action scrips is applicable to the set of test data when a data type contained in the set of test data is a data type on which the predefined features engineering action script is configured to operate.

6. The method of claim 1, wherein operation of the recommended features engineering action script on the set of target data results in data being added to the set of target data.

7. The method of claim 1, wherein the identifying comprises feeding the set of test data to a recommendation system.

8. The method of claim 7, wherein the recommendation system is trained by:
building, by the processing system, a set of training data, wherein the building is based on prior usages of the plurality of predefined features engineering action scripts in previously constructed machine learning models; and
feeding, by the processing system, the set of training data to the recommendation system, wherein operation of the recommendation system on the set of training data trains the recommendation system as a classification model which classifies a data type according to types of predefined features engineering action scripts by which the data type may be operated on.

9. The method of claim 1, wherein the at least one predefined features engineering action script comprises a generic script that is customizable for a plurality of use cases.

10. The method of claim 1, wherein the at least one predefined features engineering action script is created by another user via a first user interface and saved to a library that stores the plurality of predefined features engineering action scripts.

11. The method of claim 10, further comprising, prior to the building:
presenting, by the processing system to the another user, the first user interface; and
generating, by the processing system, a generic features engineering action script based on inputs to the first user interface that are provided by the another user.

12. The method of claim 11, further comprising:
generating, by the processing system, a second user interface by which the generic features engineering action script can be customized.

13. The method of claim 12, wherein the second user interface comprises at least one field for receiving a value that customizes a parameter of the generic features engineering action script.

14. A non-transitory computer-readable medium storing instructions which, when executed by a processing system including at least one processor, cause the processing system to perform operations, the operations comprising:
building a set of test data for a machine learning model, wherein the building is performed in response to receiving a target data set from a user, wherein the target data set is a data set on which the machine learning model is to be trained to operate;
identifying a subset of predefined features engineering action scripts from among a plurality of predefined features engineering action scripts, wherein the subset of predefined features engineering action scripts is determined to be applicable to the set of test data; and
automatically generating a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

15. The non-transitory computer-readable medium of claim 14, wherein a predefined features engineering action script of the subset of predefined features engineering action scrips is applicable to the set of test data when a data type contained in the set of test data is a data type on which the predefined features engineering action script is configured to operate.

16. The non-transitory computer-readable medium of claim 14, wherein the identifying comprises feeding the set of test data to a recommendation system, and wherein the recommendation system is trained by:
building a set of training data, wherein the building is based on prior usages of the plurality of predefined features engineering action scripts in previously constructed machine learning models; and
feeding the set of training data to the recommendation system, operation of the recommendation system on the set of training date trains the recommendation system as a classification model which classifies a data type according to types of predefined features engineering action scripts by which the data type may be operated on.

17. The non-transitory computer-readable medium of claim 14, wherein the at least one predefined features engineering action script comprises a generic script that is customizable for a plurality of use cases.

18. A device comprising:
a processing system including at least one processor; and
a non-transitory computer-readable medium storing instructions which, when executed by the processing system, cause the processing system to perform operations, the operations comprising:
building a set of test data for a machine learning model, wherein the building is performed in response to receiving a target data set from a user, wherein the target data set is a data set on which the machine learning model is to be trained to operate;
identifying a subset of predefined features engineering action scripts from among a plurality of predefined features engineering action scripts, wherein the subset of predefined features engineering action scripts is determined to be applicable to the set of test data; and
automatically generating a recommended features engineering action script for operating on the target data set, wherein the automatically generating comprises customizing at least one parameter of at least one predefined features engineering action script of the subset of predefined features engineering action scripts to extract data values from at least one location in the target data set, and wherein the recommended features engineering action script is recommended to the user for inclusion in a features engineering component of the machine learning model.

19. The device of claim 18, wherein a predefined features engineering action script of the subset of predefined features engineering action scrips is applicable to the set of test data when a data type contained in the set of test data is a data type on which the predefined features engineering action script is configured to operate.

20. The device of claim 18, wherein the identifying comprises feeding the set of test data to a recommendation system, and wherein the recommendation system is trained by:
building a set of training data, wherein the building is based on prior usages of the plurality of predefined features engineering action scripts in previously constructed machine learning models; and
feeding the set of training data to the recommendation system, operation of the recommendation system on the set of training date trains the recommendation system as a classification model which classifies a data type according to types of predefined features engineering action scripts by which the data type may be operated on.
